(19) United States
(12) Patent Application Publication
(10) Pub. No.: US 2024/0180351 A1
(43) Pub. Date: Jun. 6, 2024

(54) HEATED MIST GENERATOR, STEAM GENERATOR AND RELATED METHODS

(71) Applicant: ILLINOIS TOOL WORKS INC., Glenview, IL (US)

(72) Inventors: Gopinath Prakasam, Plain City, OH (US); Adam J. Karabin, Beavercreek, OH (US); Alexander R. Anim-Mensah, Miamisburg, OH (US); Jarrad Johnson, Troy, OH (US)

(21) Appl. No.: 18/521,149

(22) Filed: Nov. 28, 2023

Related U.S. Application Data
(60) Provisional application No. 63/430,126, filed on Dec. 5, 2022.

(51) Int. Cl. A47J 27/04; A23L 5/10; A47L 15/42; F24C 15/32

(52) U.S. Cl. CPC A47J 27/04; A23L 5/13; A47L 15/4234; F24C 15/325; F24C 15/327; A47J 2027/043; A47L 2601/04

(57) ABSTRACT

A cooking device includes a cooking chamber, a mist generator external of the cooking chamber and plumbed via a line to an inlet of the cooking chamber; and a heater located along the line for selectively heating the mist prior to delivery into the cooking chamber.

### TECHNICAL FIELD

This application relates generally to steam generators for use in commercial food equipment, such as combination ovens.

### BACKGROUND

Steam generators are used in a variety of applications such as combination ovens (e.g., ovens employing both steam and convection cooking, simultaneous, independently or in an overlapping manner) or steam cooking ovens. Many such steam generators are used in high volume situations. A typical steam generator takes the form of a hot water steam generator that includes a heating chamber with a reservoir (e.g., within a tank) with one or more associated heating elements (e.g., resistive heating elements or heat exchange tubes through which combustion gases flow) that are used to heat water within the tank to produce steam. As steam is produced and exits the tank (e.g., for delivery to an oven cooking chamber/cavity), water is added back into the tank to replace what was boiled off. Boilerless steam generation is also known, in which water (typically cold or ambient) is sprayed onto a hot surface (e.g., within the cooking chamber or a space adjacent the cooking chamber) to instantly produce steam and the steam is then circulated using convection via an oven fan wheel.

Some disadvantages of such hot water steam generators include: salt and scale deposition (which results in the need to delime), the high energy needed to generate steam, the time needed to generate steam, the inability of detergent to reach tight spaces inside the cavity, and the necessity to include a smoker component to add flavor.

U.S. Pat. No. 10,966,432 discloses a process and apparatus for heating an oven using nebulized water particles and compressed air including the steps of heating water contained in a reservoir that is located outside of a cooking chamber by transferring water within the reservoir through a water heater to reach a desired end point temperature that is less than boiling, heating compressed air by sending compressed air through an air heater that is submerged within the water of the reservoir, conveying the heated water and the heated compressed air to a nebulizer, nebulizing the heated water into heated water particles and introducing the heated water particles into the cooking chamber via the heated compressed air. This system also suffers from disadvantages related to heating of the water in the reservoir, and lack of temperature control.

It would be desirable to provide an oven steam generator that addresses one or more of the above-noted disadvantages.

### SUMMARY

In one aspect, a cooking device includes a cooking chamber, a mist generator external of the cooking chamber and plumbed via a line to an inlet of the cooking chamber; and a heater located along the line for selectively heating the mist prior to delivery into the cooking chamber.

In embodiments, the mist generator comprises a tank, and a transducer submerged within the tank, and a fan positioned for delivering air into the tank and moving mist along the line to the inlet of the cooking chamber.

In another aspect, a method of cooking a food item involves: placing the food item in a cooking chamber; introducing vibration into a reservoir of water to generate a mist; delivering the mist from the reservoir into the cooking chamber; and heating the mist as it travels along a path from the reservoir to the cooking chamber.

In a further aspect, an apparatus includes a processing chamber, a mist generator external of the processing chamber and plumbed via a line to an inlet of the processing chamber, and a heater located along the line for selectively heating the mist prior to delivery into the processing chamber. In embodiments, the apparatus is an oven and the processing chamber is a cooking chamber for food or the apparatus is a warewasher and the processing chamber is a chamber for cleaning wares.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a schematic view of a cooking system;

FIG. 2 shows an exemplary mist generator and associated plumbing to an oven;

FIG. 3 shows one example of an in-line heater; and

FIG. 4 shows another example of an in-line heater.

### DETAILED DESCRIPTION

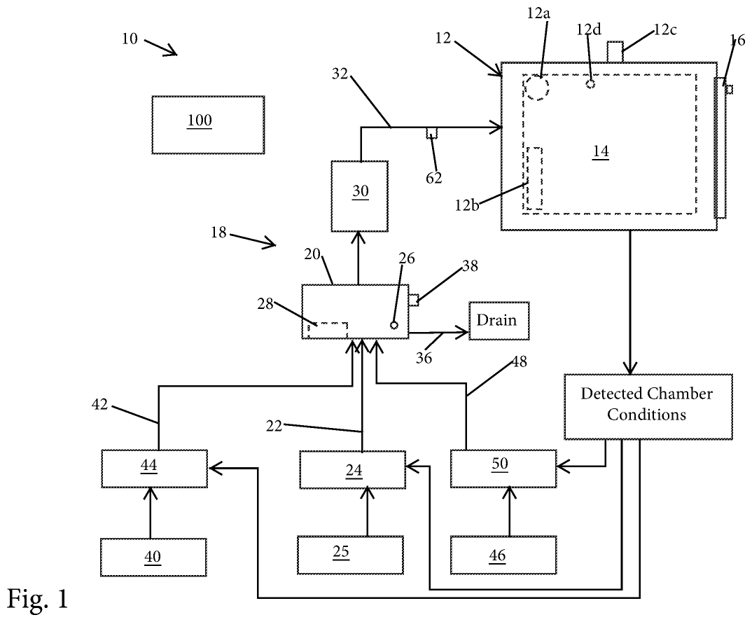

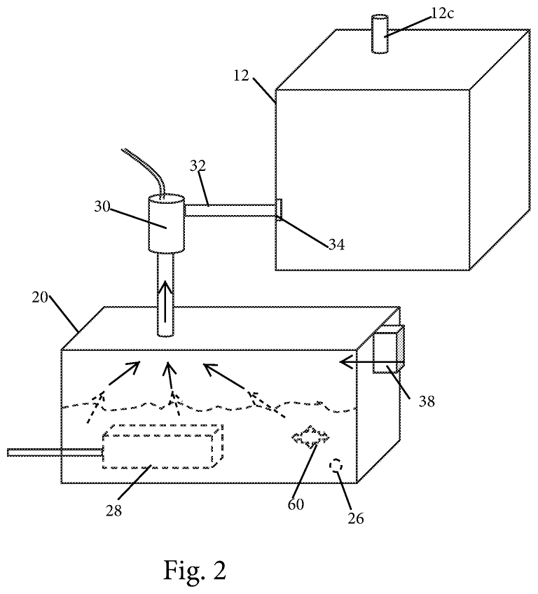

Referring to FIGS. 1-2, a cooking system 10 includes a combination oven or steam oven 12 (e.g., with fan 12a and/or heating elements or heat exchanger 12b and/or steam exhaust 12c and/or cavity sensors 12d (e.g., temperature, humidity etc.)) defining a cooking chamber 14 in which food can be cooked. The chamber 14 is accessible via a door 16 that is movable between open and closed conditions relative to the chamber 14. A steam generator 18, is located external of the cooking chamber, and is plumbed via line 32 to an inlet 34 of the steam cooking chamber 14.

The steam generator 18 includes a mist generator formed by a tank 20 with an associated fill line 22 and water fill valve 24 for delivering water to the tank from a water supply or input 25. One or more sensor(s) 26 are located to detect the water level in the tank. At least one transducer 28 (e.g., ultrasonic transducer) is located within the tank, in a location so as to be normally submerged (entirely or at least partly) within water during operation. The steam generator 18 also includes an associated fan 38 to push air into the tank 20, a heater 30 along the line 32, and a drain path 36. Operationally, the ultrasonic transducer 28 is operated to generate a water mist in the tank 20 (e.g., the vibrations produced push microscopic water droplets into the air). More specifically, ultrasonic transducers utilize piezo electric elements that vibrate ultrasonically when supplied with voltage. This vibration sets up pressure waves in the water contained in the tank, and causes some of the water to then be atomized, producing the mist. The fan 38 is operated to move the mist along the line 32, and the heater 30 is operated to heat the mist to a desired temperature (e.g., according to a temperature setting which could vary depending upon an operating mode of the cooking system), which could be between 140° F. and 230° F. The water level sensor(s) 26 is/are used to control infeed of more water, as needed, by operation of the valve 24. The system is able to deliver either heated mist (e.g., below 212° F.), vapor pressure steam (e.g., at 212° F.), dry steam (e.g., 213° F.) or superheated steam (e.g., 220 to 230° F.) to the cooking chamber as required to achieve different cooking functions and/or environmental conditions within the cooking chamber.

A controller 100 is provided for controlling the various components for the production of steam and/or heated mist. As used herein, the term controller is intended to broadly encompass any circuit (e.g., solid state, application specific integrated circuit (ASIC), an electronic circuit, a combinational logic circuit, a field programmable gate array (FPGA)), processor(s) (e.g., shared, dedicated, or group—including hardware or software that executes code), software, firmware and/or other components, or a combination of some or all of the above, that carries out the control functions of the device or the control functions of any component thereof. The controller 100 may control components 28, 30, 38, 44, 24 and 50, and may also control other components and features of the oven 12 (e.g., convection heating elements 12b and fan motor 12a, exhaust flow, user interface display, etc.). The controller may also receive feedback inputs from sensors 12d, 26, 62 and others.

Notably, the system 10 also includes the ability to incorporate flavors into the heated mist/steam that is delivered to the cooking chamber 14 by way of feeding of a flavoring from flavoring supply 40 along line 42 into the tank 20 via selective operation of a valve 44 (e.g., based upon an oven recipe or a setting established for a cooking operation). The flavoring becomes dispersed into the water and will also be incorporated into the mist upon operation of the transducer(s) 28.

In addition, the system may facilitate cleaning of the cooking cavity by delivery of detergent (or delime chemical) from a detergent supply (or delime supply) 46 along line 48 into the tank 20 via selective operation of a valve 50 (e.g., based upon a cleaning mode setting of the oven). The detergent becomes dispersed into the water and will also be incorporated into the mist upon operation of the transducer(s) 28. Upon delivery of the water/detergent mist (heated or not heated) into the cooking chamber 14, the mist will condense on surfaces, including surface portions or regions that might be difficult to reach manually, to provide cleaning.

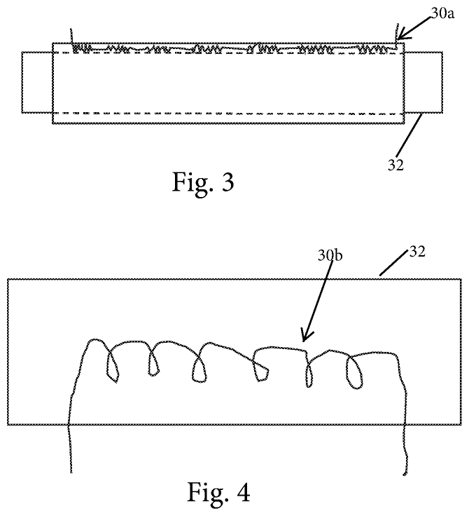

With respect to the in-line heater 30, exemplary heaters that might be used include both external heaters (heater(s) outside the flow path of the mist) and internal heaters (heater(s) in the flow path of the mist). For example, an external heater may be in the form of (i) a flexible silicone resistive heater that is wrapped about the tube/pipe through which the mist runs or (ii) an insulated gas line heater element disposed about the tube/pipe, in either case, with heat being transferred through the wall of the tube/pipe to the mist. An internal heater may, for example, be of a shell in tube configuration. Exemplary external heater 30a and internal heater 30b are shown schematically in FIGS. 3 and 4. The heaters may include integrated sensors to facilitate temperature control of the fluid delivered to the cooking cavity and/or an inline temperature sensor (e.g., 62) could be provided for such purpose.

In embodiments, the oven controller is configured with multiple operating modes, such as multiple cooking modes and a cleaning mode, and each mode includes corresponding settings that dictate how the mist generation will be handled, heated and delivered. The table below is exemplary, and more variables could be included for each mode.

TABLE 1
Settings By Operating Program Mode

| | Transducer | Fan State | Target Mist | | |
|---|---|---|---|---|---|
| Mode | State or Freq. | or Speed | Temp | Flavor | Detergent |
| Cook1 | TS1 | FS1 | TMT1 | Yes | No |
| Cook2 | TS2 | FS2 | TMT2 | No | No |
| Clean1 | TS3 | FS3 | TMT3 | No | Yes |

It is to be clearly understood that the above description is intended by way of illustration and example only, is not intended to be taken by way of limitation, and that other changes and modifications are possible. For example, in some embodiments the fan 38 may not be needed, and the system may rely upon an air mover of the oven 12 to pull the mist into the cooking cavity. In addition, in some embodiments a heater (e.g., resistive heater or heat exchanger 60) may be placed in the tank to heat the water in the tank to some desired temperature that is less than boiling. Incorporation of the mist generator into other commercial food equipment devices with other types of processing chambers (other than cooking chambers), such as warewashers in which the processing chamber is used for cleaning/rinsing or wares, is also possible.

Advantages of the above-described system include: (i) ability to control the temperature of the mist delivered to the cavity using the in-line heater, (ii) ability to atomize fragrances and/or detergents to pacify odors in the cavity, (iii) ability to mist flavored water and cook the product with the flavored mist, (iv) ability to mist liquid detergent (or delime agent) to reach tight corners within the cavity, (v) minimal scaling within the mist generator tank (as compared to a steam generator) as well as the cavity, (vi) better energy efficiency due to less water heating and less heat loss through the tank surface area (as compared to a steam generator). (vii) decreased water usage for the purpose of steam generation (e.g., by 15-20%) as compared to a current steam generator), and (viii) ability to inject super-heated steam into the cavity when required.

1. A cooking device, comprising:
a cooking chamber;
a mist generator external of the cooking chamber and plumbed via a line to an inlet of the cooking chamber; and
a heater located along the line for selectively heating the mist prior to delivery into the cooking chamber.

2. The cooking device of claim 1, wherein the mist generator comprises a reservoir, and a transducer submerged within water in the reservoir for vibrationally producing mist from the water.

3. The cooking device of claim 2, wherein the mist generator further comprises a fan positioned for delivering air into the reservoir and moving mist along the line to the inlet of the cooking chamber.

4. The cooking device of claim 2, wherein the mist generator further comprises an input line connected to selectively receive, into the reservoir, a flavoring liquid from a flavor supply.

5. The cooking device of claim 2, wherein the mist generator further comprises an input line connected to selectively receive, into the reservoir, detergent and/or delime agent from a detergent and/or delime agent supply.

6. The cooking device of claim 2, further comprising a controller connected for controlling the transducer, the fan and the heater.

7. The cooking device of claim 6, wherein the controller is configured for selectively heating the mist to a set temperature.

8. The cooking device of claim 7, wherein the set temperature is below 212° F.

9. The cooking device of claim 7, wherein the set temperature is 212° F.

10. The cooking device of claim 7, wherein the set temperature is above 212° F.

11. The cooking device of claim 7, wherein the controller is configured such that the set temperature is defined by a cooking program of the cooking device or a cooking setting established for a cooking operation.

12. The cooking device of claim 1, wherein the cooking device comprises a steam cooker or a combination oven that also includes a convection heating system.

13. An apparatus, comprising:
a processing chamber;
a mist generator external of the processing chamber and plumbed via a line to an inlet of the processing chamber; and
a heater located along the line for selectively heating the mist prior to delivery into the processing chamber.

14. The apparatus of claim 13, wherein:
(i) the apparatus is an oven and the processing chamber is a cooking chamber for food;
or
(ii) the apparatus is a warewasher and the processing chamber is a chamber for cleaning wares.

15. A method of cooking a food item, comprising:
placing the food item in a cooking chamber;
introducing vibration into a reservoir of water to generate a mist;
delivering the mist from the reservoir into the cooking chamber; and
heating the mist as it travels along a path from the reservoir to the cooking chamber.
